(19) United States
(12) Patent Application Publication
(10) Pub. No.: US 2012/0144392 A1
(43) Pub. Date: Jun. 7, 2012

(54) Resource Manager for Managing Hardware Resources

(75) Inventors: Carlos Freitas, London (GB); Parameshwari Balusamy, Surrey (GB)

(73) Assignee: NOKIA CORPORATION, Espoo (FI)

(21) Appl. No.: 13/001,908

(22) PCT Filed: Jun. 26, 2009
(86) PCT No.: PCT/IB2009/052771

§ 371 Date: Jan. 18, 2012

(30) Foreign Application Priority Data
Jun. 30, 2008 (GB) 0811943.0

(51) Int. Cl. G06F 9/46

(52) U.S. Cl. 718/100

(57) ABSTRACT

A resource manager is provided, which is configured to manage a plurality of hardware resources in a computing device. The resources are managed in dependence on a record of each of the plurality of hardware resources, and an indication of dependencies between the plurality of hardware resousrces.

### TECHNICAL FIELD

The present invention relates in certain embodiments to a computing device and, in further embodiments, to maintaining a record of hardware resources in a computing device.

### BACKGROUND TO THE INVENTION

Many computing devices have the option of operating as mobile computing devices. This does however require a mobile power source, most often in the form of a battery. However, mobile power sources are limited in the duration for which they can deliver power to the computing device.

A “hardware component” may refer to an element of a computing device which provides certain functionality to a user of that device. Likewise, the term “hardware resource” may be used to refer to any portion of the hardware of the device which is controllable by software of the device. Software that use hardware resources (such as device drivers, kernel dlls, etc.) may be referred to as the “clients” of these resources. Dependent resources may be referred to as “parent” and “child” resources where the “child” resource is dependent upon the “parent” resource.

Computing devices comprise a number of hardware resources such as clock sources, controllable voltage regulators, power switches, and other hardware components of the devices such as cameras or displays are controlled by means of these hardware resources. However, these hardware resources are often interdependent so a change to a certain resource may have unintended consequences on other resources and therefore on the corresponding hardware components. Furthermore, certain resources may rely on other resources.

### SUMMARY OF THE INVENTION

An embodiment of the invention extends to a resource manager configured to manage a plurality of hardware resources in a computing device in dependence on a record of each of said plurality of hardware resources and an indication of dependencies between said plurality of hardware resources.

A further embodiment of the invention extends to a method comprising: establishing a record of each of a plurality of hardware resources in a computing device, and maintaining an indication of dependencies between said plurality of hardware resources.

A further embodiment of the invention extends to a computer readable memory storing a computer program, said computer program being configured, when operating on a processor of a computer to cause the processor to perform the aforementioned method.

A further embodiment of the invention extends to a resource manager configured to manage a plurality of hardware resources in a computing device, said resource manager being configured to:
determine a dependent power resource being dependent on at least one of said plurality of a resources;
determining whether a change to at least one of said resources affects the dependent power resource in an acceptable manner; and
if said change affects the dependent power resource in an acceptable manner, changing said power state of said at least one resource.

In embodiments of the invention, by maintaining indications of dependencies between hardware resources, a model of the interdependencies between resources may be maintained and used for maintenance of a computing device by, for example, conserving the power consumption of the device.

Embodiments of the invention rely on a record for a hardware resource and, provided such a record exists or may be generated, embodiments may be scaled to incorporate relatively large numbers of resources and dependencies. Furthermore, embodiments of the invention are not platform, operating system or hardware dependent.

### BRIEF DESCRIPTION OF THE DRAWINGS

Embodiments of the invention are hereinafter described with reference to the accompanying diagrams where:

FIG. 1 is a schematic diagram of a mobile computing device;

FIG. 2 is a block diagram representing a portion of the mobile computing device of FIG. 1 incorporating an embodiment of the invention;

FIG. 3 illustrates tabular representations of certain hardware components, hardware resources and corresponding states for the device of FIG. 1 according to an embodiment of the invention;

FIG. 4 is a graph of dependencies between hardware resources of FIG. 3;

FIG. 5 is a graph of dependencies between hardware resources of a mobile computing device according to an embodiment of the invention;

FIG. 6 is a process diagram for verifying the consequences of a change of state of a target node in a hardware resource dependency graph according to an embodiment of the invention;

FIG. 7 is a process diagram for changing a state of a node in a hardware resource dependency graph according to an embodiment of the invention; and

FIG. 8 is a process diagram illustrating a process for changing the state of a resource according to an embodiment of the invention.

### DESCRIPTION OF EMBODIMENTS

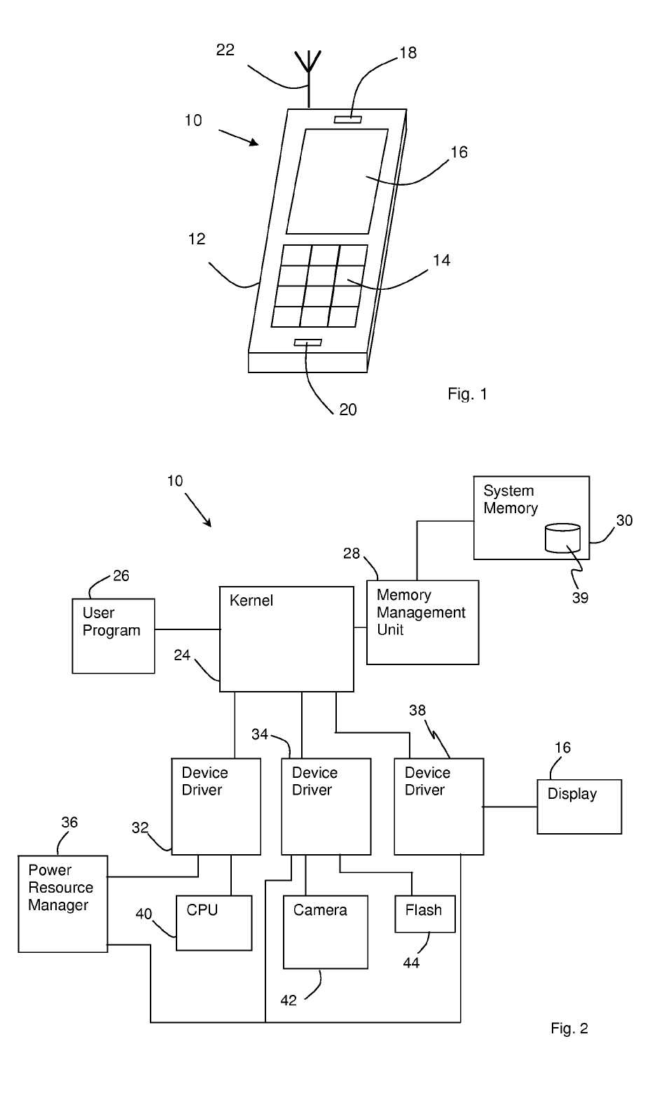

FIG. 1 is a schematic diagram of a mobile computing device 10 having a casing 12. The casing 12 encapsulates a keypad 14, a display 16, a speaker 18 and a microphone 20. The device 10 further includes an antenna 22. The mobile computing device 10 illustrated in FIG. 1 may function as a phone and, in this instance, sends and receives telecommunication signals via antenna 22. Although the computing device 10 is a mobile computing device, other embodiments of the invention are implemented on computing devices which are not necessarily mobile.

FIG. 2 is a schematic illustration of certain components of the mobile computing device 10. Device 10 includes a kernel 24 which represents the operating system of the device 10. In the embodiment shown, the operating system is the Symbian® operating system. The invention is not however limited in this respect. In this embodiment the kernel 24 is operably connected to a system memory 30 by means of a memory management unit 28. Device drivers 32, 34 and 38 are operably connected to the kernel 24 and control the behaviour of, and certain communications with, respective hardware components: central processing unit (CPU) 40; camera 42; flash 44; and display 16. A user interacts with the device 10 by means of user programs, one of which, user program 26, is illustrated in FIG. 2. User program 26 communicates with the hardware of the device 10 (such as the display 16) by means of the kernel 24 and the respective device drivers. It is to be realised that the mobile computing device 10 includes many more hardware components than those illustrated here. These aspects of computing devices are known in the art and will therefore not be further described herein.

A power resource manager 36 is operably connected to the device drivers 32, 34 and 38 and is able to control the hardware resources of the hardware components of the device 10 by interacting with their corresponding device drivers. In the illustration of FIG. 2, the power resource manager 36 has been illustrated as a component separate from the kernel 24. However, the power resource manager 36 may be implemented as part of the kernel 24; embodiments of the invention are not influenced by the manner in which the power resource manager is implemented. In an embodiment, the power resource manager 36 is a relatively low-level component which has direct access to the various hardware components of the device 10 (i.e. the resource manager 36 is able to change the states of the resources of the hardware components to which it is connected without having to negotiate that change with any other hardware resources or the kernel 24).

The power resource manager 36 maintains a record of those hardware components and resources which are adapted to be registered with the power resource manager 36. This record is maintained in a resource manager database 39 maintained in the system memory 30. The resource manager database is populated by the resource manager which publishes an application programming interface (API) through which hardware components are able to register their hardware resources. Hardware components may be considered to include at least two kinds: static and dynamic components. Static components and their corresponding resources are those hardware components which will always be present in the device and cannot be removed without disabling the device (e.g. the display 16). Dynamic components and their corresponding resources are those which may be installed and removed while the device 10 is operational (e.g. flash memory).

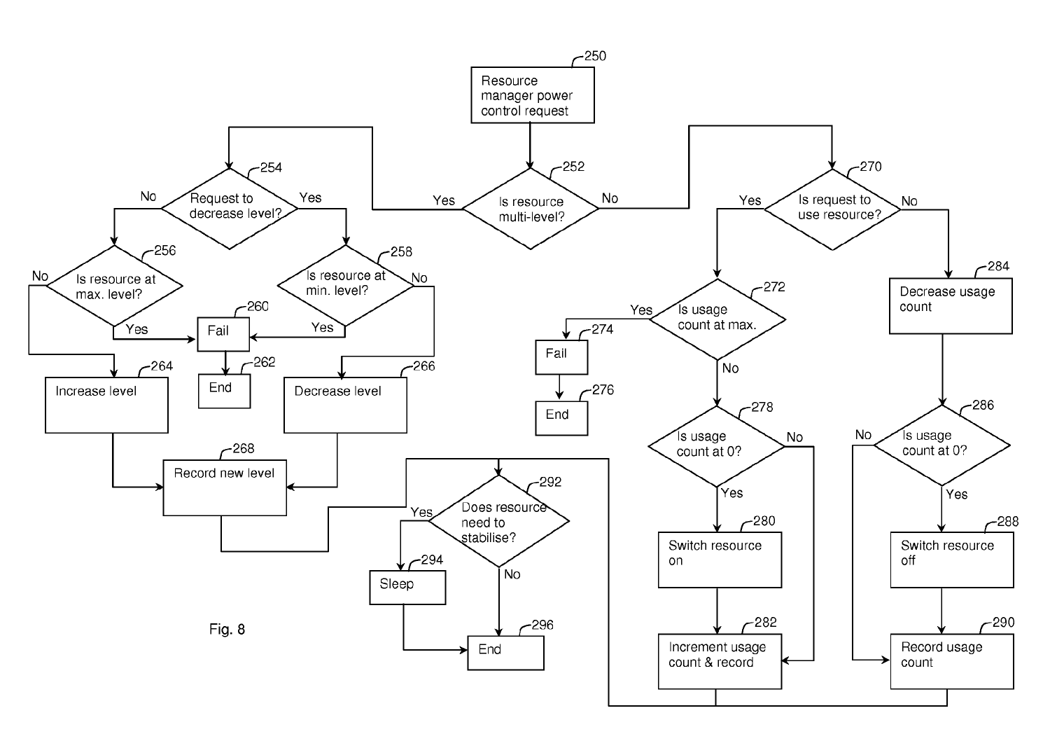

Both static and dynamic resources may be further categorised as being binary resources or multi-level resources. Binary resources are those hardware resources which may be either on or off. Multi-level resources are those hardware resources where the power level may vary in increments between on and off. This will be discussed in greater detail below with reference to FIG. 8.

In certain embodiments, a record for a static resource is established when the computing device is booting. Establishing a record for a dynamic resource occurs when the dynamic resource is added to the computing device. The records according to embodiments of the invention are able to accommodate both static and dynamic hardware components and their resources. A record may be deleted when the corresponding resource is removed from the device. In this manner the records may be kept up to date to correctly reflect the resources available in the computing device.

The manner in which registration of a resource occurs will depend on whether that resource belongs to a static or a dynamic hardware component. The registration of static resources occurs at boot time of the device 10 whereas the registration of dynamic resources occurs when the corresponding component is installed. Likewise, deregistration of a static resource will occur when the device 10 is switched off, whereas deregistration of a dynamic resource will occur when the corresponding component is removed.

The indication of dependencies between the plurality of hardware resources may include an indication of a dependency for each record corresponding to a dependent hardware resource. The dependencies may be power dependencies.

Where the resources relate to power consumption, careful control over the amount of power the device consumes may be exercised by use of embodiments of the invention, which in turn provides for a more efficient computing device. By keeping track of the power dependencies of hardware resources, it is possible in embodiments to ensure that these resources do not consume more power than needed to maintain their functionality, resulting in a more efficient utilisation of available power.

In certain embodiments all of the dependencies for a target resource are determined. In alternate embodiments only one or some of the dependencies for one or more target resources are determined.

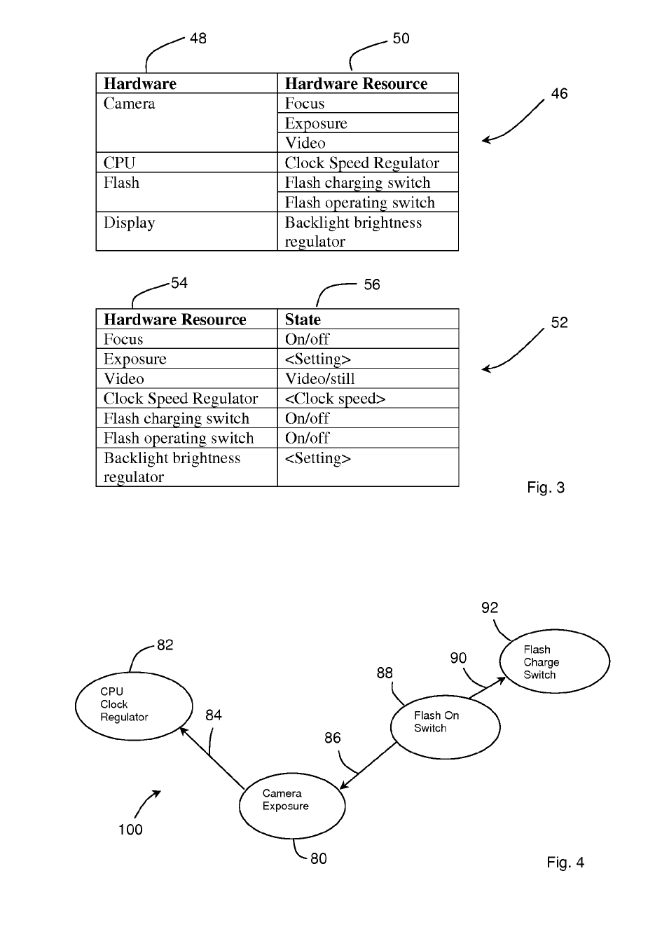

FIG. 3 illustrates the kind of data registered with the resource manager 36, which is a power resource manager, in tabular form. Table 46 includes two columns: a hardware column 48 and a hardware resource column 50. The hardware components: camera 42, CPU 40, flash 44 and display 16 are listed under the hardware column 48 by way of example. It is to be realised that the power resource manager 36 is capable of registering information relating to many more hardware components than those shown in FIG. 3.

Also illustrated in table 46 are the hardware resources corresponding to the hardware components of column 48, listed in column 50. Therefore the camera 42 has hardware resources: (in this example) focus, exposure and video. The focus resource is an automatic focus feature, the exposure feature sets the aperture of the camera and the video resource determines whether a still picture or a video is captured by the camera. In a similar vein, the CPU 40 has a clock speed regulator resource which determines the speed of the CPU 40. The flash component has a flash charging switch which allows charging of the flash, and an operating switch which operates the flash. The screen has a backlight brightness regulator which determines how bright the backlight of the screen is.

Table 52 of FIG. 3 contains each of the hardware resources listed in column 50 of table 46 (here listed in column 54). With each resource, the states for that resource are listed in column 56. Certain of the states relate to binary resources and therefore have a binary setting such as the focus resource which is either on or off; determining whether the automatic focus feature of the camera is enabled or not. Other resources relate to multi-level resources and therefore have states which can take one of a plurality of settings. This has been indicated by the label “<setting>”. For example, the CPU speed regulator may be set so that the CPU speed is one of three values: LOW, MEDIUM or HIGH.

However, the tables of FIG. 3 do not illustrate the dependencies between the resources. To keep track of these dependencies, the power resource manager 36 of this embodiment maintains the information relating to the hardware components and hardware resources of the device 10 as a graph. The graph is stored in the resource manager database 39. The nodes of the graph represent the resources and the edges of the graph represent the dependencies between the resources. In this respect, in this embodiment, the notes of the graph may be considered as records of the resources and the edges as indications of the dependencies between resources.

In certain embodiments, the dependencies between resources may be represented by a graph, wherein each of the records is a node in the graph and the dependencies are edges of the graph.

A graph is particularly well suited for modelling the interdependencies between hardware resources in a computing device as, in this way, relatively complex dependencies may be modelled using a relatively simple and easy to maintain structure. Furthermore graphs scale easily and can be adapted to model various hardware platforms and operating systems.

In embodiments, edges of the graph may be weighted according to the priorities of the dependencies.

A simple example of a graph 100 for certain of the resources illustrated in FIG. 3 is shown in FIG. 4. The camera exposure resource is represented by node 80, the CPU clock regulator is represented by node 82, the flash on switch is represented by node 88 and the flash charge switch is represented by node 92.

As stated, the dependencies between resources are the edges of graph 100. To calculate the required aperture for the camera 32 in a reasonable amount of time, a minimal setting for the CPU speed is required. Therefore, the camera exposure resource is dependent on the CPU clock regulator resource. This is reflected by directed edge 84 from node 80 to node 82. Node 82 is therefore the parent of child node 80.

Similarly, in this embodiment, the flash on switch resource (node 88) requires the exposure setting to be calculated and set by the exposure resource (node 80). Therefore, directed edge 86 extends from node 88 to node 80. The flash on switch resource (node 88) is also dependent on the flash charge switch (node 88) as the flash cannot be operated unless it has been charged. This dependency is illustrated by directed edge 90 from node 88 to node 92.

The example graph of FIG. 4 is a relatively simple structure. In practice, the dependency graph for a device may be more complex than the graph illustrated in FIG. 4. For example, the graph of FIG. 4 only illustrates single dependencies between nodes. However, some resources will be directly dependent on more than one other resource. In this instance, the graph may include weighted edges, where the edges are weighted according to the priorities of the dependencies.

When a selected resource has more than one dependency, a priority associated with each dependency of the selected resource may be included in a record corresponding to the selected resource. Prioritising the dependencies ensures that any use of the records to change states or to notify clients of the resources may be executed in order of the priorities of the resources.

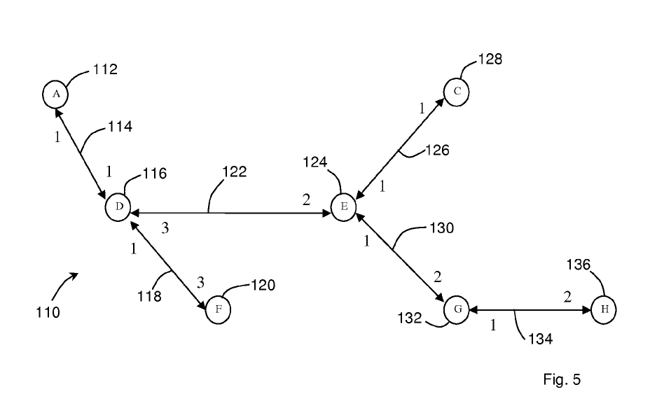

FIG. 5 illustrates a more complex graph 110 of resource dependencies. Graph 110 illustrates the dependencies for the hypothetical resources A (node 112), D (node 116), F (node 120), E (node 124), C (node 128), G (node 132) and H (node 136). As illustrated by FIG. 5 the following nodes are dependent upon one another: nodes A 112 and D 116 (edge 114); nodes D 116 and E 124 (edge 122); nodes D 116 and F 120 (edge 118); nodes E 124 and C 128 (edge 126); nodes E 124 and G 132 (edge 130); and nodes G 132 and H 136 (edge 134). As each of the nodes concerned are interdependent, the edges 114, 118, 122, 126, 130 and 134 are bidirectional edges. Furthermore, as some nodes have multiple dependencies, the edges are prioritised according to the numbers appearing next to the arrow heads of the edges representing the dependencies in FIG. 5. So, for example, the hardware resource represented by node D is, in order of priority, dependent upon the hardware resources represented by node A 112 (priority 1), node E 124 (priority 2) and node F 120 (priority 3).

The graphs of FIGS. 4 and 5 are representations of resources belonging to both static and dynamic components. Whether the corresponding node is added at boot time (static resource) or when the corresponding component is installed (dynamic resource), the addition of the node will involve establishing edges with dependent resources and determining the priorities of those edges. The dependencies and priorities are specified for each resource and the edges of the graph are established accordingly.

In certain embodiments, when a new node is added to the graph a check is performed to ensure that no circular dependencies are introduced. This check involves following each edge of the graph once the new node has been added and verifying that each node appears only once in the graph. It is to be realised that more than one graph may be used to represent all of the resources of a computing device.

Circular dependencies can result in a feed-forward situation where a process which relies on the records is stuck in a loop. By checking that no circular dependencies exist, the likelihood that the device is caught in a loop may be minimized

In these embodiments, the verification that no circular dependencies exist for a record is performed after the record is established and before the record is utilised. By checking for circular dependencies before the record is used, the likelihood that the device will enter into a wasteful loop may be reduced.

Furthermore, in these embodiments a determination is made as to an effect a change of state of a target state will have on one or more resources determined to be dependent on the target resource. Such an initial test can ensure that the eventual change will not result in an error.

In embodiments a determination is made, for each resource determined to be dependent, whether there are other resources dependent on said dependent resources, and this determination is repeated until all dependent resources have been found and an effect a change of state said target state will have on each resource found to be dependent is then determined. In this case, the state of said target resource may only be changed if an effect of the change on each resource dependent on the target resource is determined to be acceptable.

If it is required to change a state of one of the resources, then a check is made that the proposed state (i.e. the target state) is compatible with the states of the nodes of the dependent resources. If more than one dependency exists, dependent nodes are checked in order of priority. In one embodiment, only if it has been verified that the state change is allowable, will the state change be implemented.

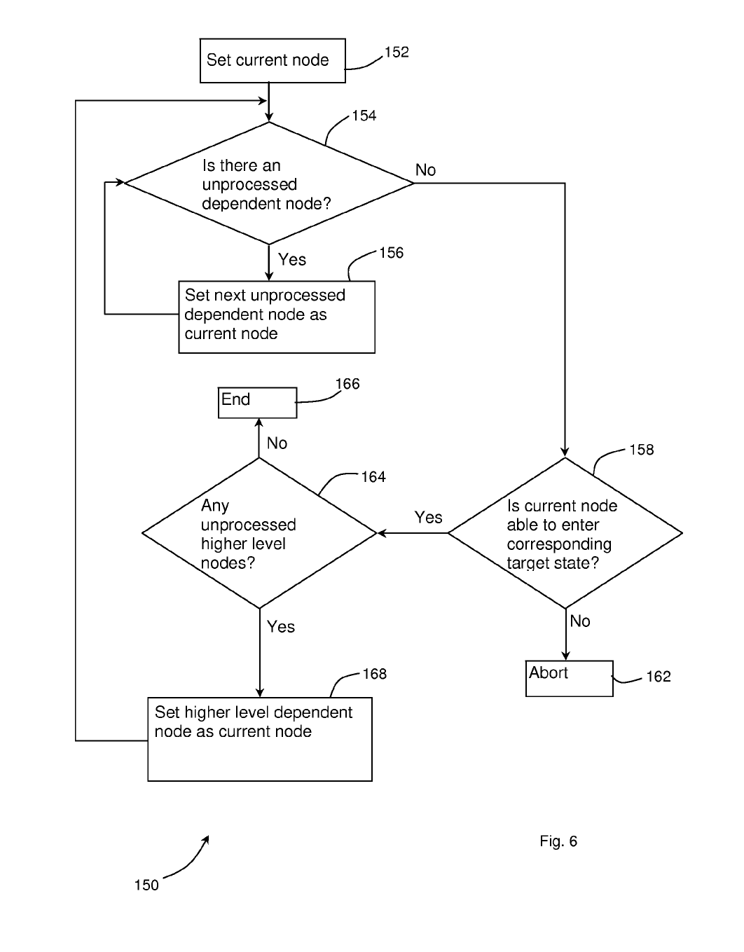

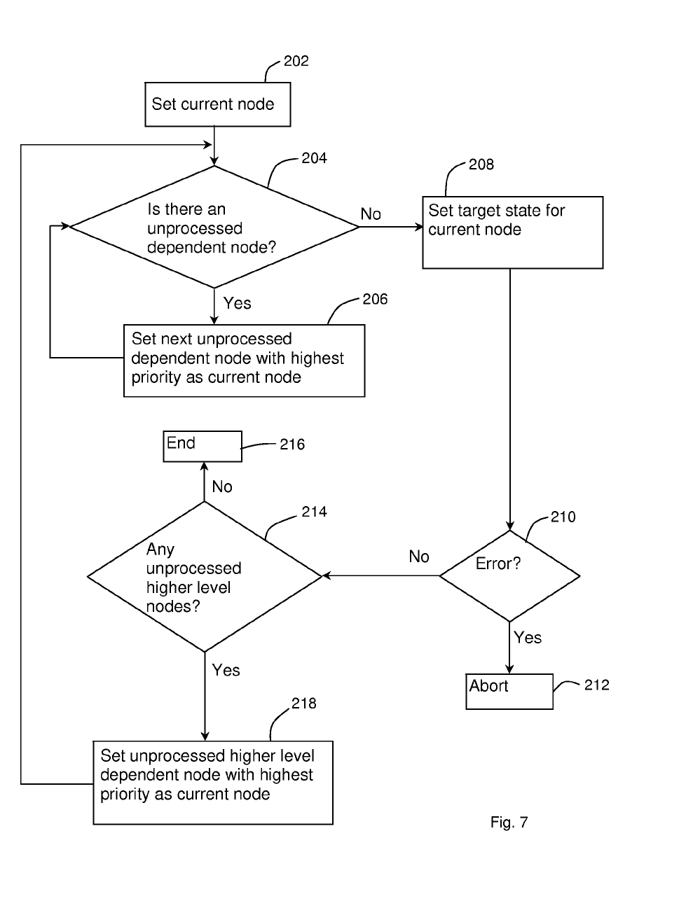

FIG. 6 illustrates an example process for verifying that a target state for a resource is compatible with the other resources which are dependent upon this resource and which this resource depends on. For the sake of clarity, the resource for which the state is to be changed is referred to as the “target resource” and the corresponding node as the “target node”. In the embodiment illustrated, the processes of both FIG. 6 and FIG. 7 is carried out by the resource manager 36.

Referring to FIG. 6, the target node is set as the current node in block 152. The process then moves to block 154 where it is determined whether there are any unprocessed dependent nodes for the current node. As the current node is the target node and this block 154 has not previously been implemented, it will be determined here whether there are any nodes which the target node depends on, or which are dependent upon the target node. If there are no such dependent nodes, the process will move to block 158 where the intended target state will be checked for the target node. In other words, at block 158 it is determined whether the target node is able to enter the state designated as the target state.

As previously described, a node corresponds to a hardware resource which is controlled by software. The software may include relevant information used to determine whether a node is able to enter a particular state or not. This may depend on the states of the dependent nodes and therefore block 158 may, in appropriate circumstances, involve ascertaining the states of all (or only some) dependent nodes and comparing these to a list of un-allowable states for those nodes. If the comparison is favourable the process reports that the target node is able to enter the state designated as the target state.

In an alternative embodiment a record is maintained of both the current level of each hardware resource and the requirements of each dependent resource. If a change of state results in an increase in the power usage of the hardware resource, this is allowed unless the requested change would result in the power usage exceeding a predetermined maximum. If the state change results in a request to reduce the power usage, this is only allowed if no other request exceeds the new state. The process whereby the state of a node is changed and further considerations which determine whether a node is able to enter a target state are described below with reference to FIG. 8.

If the target node is able to enter the target state, the process continues to block 164. If there is an error reported by the test of block 158, the process will abort and thereby stop at block 162.

Returning to block 154, if it is determined that there are dependent nodes connected to the target node, the process will continue to block 156 where the first of these is set as the current node and the process will return to block 154 and test whether dependent nodes exist for this new current node. The dependent nodes will be processed in order of the priorities of their dependencies where there are more than one dependent node. A record is kept in the database 39 of which nodes have been tested for dependencies and which haven't.

As illustrated by FIG. 6, block 154 and 156 form a loop at the end of which the current node will be a node which does not have any further dependencies (this will be a terminating node). The process will then continue on to block 158 and proceed as previously set out for blocks 158 and 160, but in respect of the current node, which is now not the target node.

At block 164, the process will determine whether there are any higher level nodes in the graph for which the test of block 158 has not been performed. This is done by considering whether there are any nodes dependent upon the current node which themselves have dependent nodes which have yet to be processed. If it is determined that such unprocessed nodes exist, the process will set the next unprocessed node as the current node and return to block 154 from where it will proceed as set out above.

In this manner, each of the nodes of the graph will undergo the test of block 158 where it is determined whether that node is able to enter a state compatible with the target node entering the target state. Therefore, once the process of FIG. 6 has been completed for each required node of the graph, the power resource manager 36 is able to determine whether or not each of the resources which form a dependent relationship with the target node are able to alter their state in a manner which is compatible with the target state.

In certain embodiments of the invention a state of a target resource is altered in dependence on information compiled in the records or one or more of the indications of dependencies corresponding to the target resource.

By altering a state of a hardware resource in dependence on an indication of dependencies between hardware resources, it may be ensured that these dependencies can be taken account of when the state of one of the resources is changed. In this manner, a state for one resource which is incompatible with a state of a dependent resource may be avoided.

Once the testing process is completed successfully, the power resource manager 36 will change the state of the target node to the target state. An example process for doing so is illustrated in FIG. 7. This process is similar to that of FIG. 6.

In FIG. 7, at block 202, the target node is set as the current node. In block 204, it is determined whether there are any nodes which form a dependent relationship with the current node. If there are dependent nodes, the process will move to block 206 where the next unprocessed node with the highest priority is set as the current node and the process returns to block 204. After the loop constituted by blocks 204 and 206 is completed, the current node will be a terminal node of the graph.

In embodiments, states of the dependent resources are altered prior to altering the state of the target resource to the target state.

Where the changing of the state of a dependent resource automatically changes the state of the target resource, it is beneficial if the state of the dependent resource can be altered before that of the target resource to ensure that all resources enter the intended states. Furthermore, where there is more than one dependency between resources, a cascade effect may develop between dependent resources and, to ensure that the intended states result, it is important to change the states of the dependent resources first. Where the dependencies are depicted as a graph this is done by changing the state of those resources whose nodes reside at terminal branches of the graph.

Referring back to FIG. 7, the process will then proceed to block 208 where the state of the current node is set to that state determined by the target state of the target node. It is to be realised that for certain dependent nodes in the dependency graph, a change of state of one node will automatically change the state of another node. Therefore, the procedure of block 208 may have already been performed (for later iterations through this step). In this case, the process will proceed to block 210.

Block 210 tests for an error resulting from the setting of the state in block 208. If an error arises, the process will terminate at block 212. If no error arises, the process proceeds to block 214. At block 214 the process will determine whether there are any dependent nodes relative to the current node for which the state has not been set. If such nodes do exist, the process will continue to block 218 where the next dependent node with the highest priority for which the state has not been set is made the current node. The process then returns to block 204 with the new current node and repeats.

On the other hand, if there are no unprocessed higher level nodes detected in block 214, it is determined that all nodes of the graph have had their states set and the process ends at 216.

This process allows a state change for a resource to be set according to the priorities of its dependencies, ensuring that the state for a node is not set until the nodes which form dependent relationships therewith have first been changed appropriately.

By way of example the process of FIG. 6 is applied to the graph of FIG. 5. If we assume that the resource represented by node D 116 is to change (i.e. node D is the target node), the power resource manager will first query node A 112 (which has the highest priority of the nodes connected to node D 116) to determine what state it would need to be in for the desired change to node D to be effected and then determines if node A 112 can be moved to that state. The process is repeated for node E 124. However, before the determination can be made for node E 124 the resource power manager 36 needs to determine how the proposed change will influence nodes C 128 and G 132. Determination for node G 132 in turn requires a determination in respect of node H 136. Returning now to node D 116, a final determination is made in respect of node F 120.

Therefore, according to this embodiment, the process will determine the effect the requested change will have in the following order:

Node A 112; node C 128; node H 136; node G 132; node E 124; node F 120; and lastly node D 116.

Similarly, applying the process of FIG. 7 to the graph of FIG. 5, the changes necessitated by a change in state of the resource represented by node D 116 will be propagated in the same order:

Node A 112; node C 128; node H 136; node G 132; node E 124; node F 120; and lastly node D 116.

In certain embodiments it is desirable to notify clients of the resources represented by the graph that the states have changed. Once again the request for notification may be first propagated to all dependent nodes before the target node notifies its clients. According to these embodiments of the invention, clients of the target resource are alerted in accordance with information contained or stored in the records.

When alerting clients of the resources, the dependencies between the resources are taken into account during the notification process and this helps to ensure that the clients are correctly notified in the order of their dependencies.

In particular, the clients of each resource forming a dependency with the target resource are alerted to the change prior to clients of the target resource being alerted to the change.

With reference to the example of FIG. 5:

Any clients of node A 112 are notified, followed by clients of node C 128 followed by clients of node H 136, followed by clients of node G 132, followed by clients of node E 124 followed by clients of node F 120 followed by clients of node D 116. This process is analogous to the processes of FIGS. 6 and 7 and operates in the same manner.

FIG. 8 represents a process whereby the state of a resource is altered. As previously described, a power resource may be binary resource or a multi-level resource. For binary resources, the resource manager 36 maintains a usage counter corresponding to the resource in the database 39. The API provided by the power resource manager 36 for that resource includes a use( ) function which is called when a hardware driver requires that resource. A release( ) function is called when the particular hardware driver no longer requires that resource.

The use( ) function increments the usage counter and the release( ) function decrements the usage counter. When the usage counter changes from 0 to 1, the corresponding component is switched on. When the usage counter changes from 1 to 0, the corresponding component is switched off.

Further functions are provided by the API of the resource manager. Functions to return the current value of the usage counter as well as the current on status of the component are provided. The components may be shared amongst various device drivers and some components limit the number of device drivers which may share that component. For such components, the usage counter has a predetermined maximum level. A request to share a resource for which the usage counter has reached the predetermined maximum will be refused.

Multi-level resources are managed by the resource manager 36 in a similar way to binary resources. For multi-level resources the resource manager also maintains a usage count which is incremented and decremented according to the number of device drivers which use that resource. In addition, the resource manager keeps track of the level of the multi-level resource and only permits the level to be incremented or decremented in certain situations: if the driver requesting the change in level is the only driver using that resource (the usage count is 1), then the change is allowed. If there is more than one driver using that resource, the change will only be allowed if that change is compatible with the usage requirements of all the drivers using the resource.

Therefore, for a multi-level resource, the power resource manager 36 will additionally keep track, using database 39, of the level requirements of all drivers using the resource.

In FIG. 8, block 250 represents the receipt by the resource manager 36 of a power control request. At the following block, block 252, the resource manager 36 determines whether that resource is a multi-level resource or not. If the resource is a multi-level resource, the process will proceed to block 254 where a determination is made as to whether the received request is a request to decrease the level of the resource. If the request is a request to decrease the level, the process moves to block 256 where a determination is made as to whether the resource is at its maximum permitted level. If the resource is at the maximum permitted level, then the request to increase the level cannot be fulfilled and the process proceeds to block 260 which represents a fail state and from there the process ends at block 262.

Returning to block 256, if a determination is made that the resource is not at its maximum permitted level, the procedure will proceed to block 264 where the level is incremented. Thereafter, the process will proceed to block 268 where the new power level and usage level (if the power control request was received from a new driver) is recorded in database 39. The process will then proceed to block 292 which is discussed below.

At block 254, where the determination is made as to whether the control request is a request to decrease the power level, if the determination is positive, the process proceeds to block 258 where a determination is made as to whether the resource is at its minimum power level. If the resource is at its minimum power level, then the level cannot be decreased so the process will fail by going to fail block 260 and then end at block 262. If however the resource is not at its minimum power level, then the power level is decreased at block 266. Once the power level has been decreased, the new power level and usage level (if the power control request was received from a new driver) is recorded in database 39. The process will then proceed to block 292 which is discussed below.

Returning to block 252, if the determination is made there that the resource is not a multi-level resource then the assumption is made that the resource is a binary resource. The process proceeds to block 270 where a determination is made as to whether the request is a request to use the resource. If the request is a use request, a determination is made at block 272 to determine whether the usage count for that resource is at a maximum level. The resource manager 36 does so by querying the database 39 and determining whether the current usage level equals the stored maximum level for that resource.

If the usage count is determined to be at a maximum at block 272 no additional drivers may be supported by the requested resource and therefore the request will fail at block 274. The process will then end at block 276. If however a determination is made at block 272 that the resource has not attained its maximum usage level, the process will proceed to block 278 where it is determined whether the usage count for the resource equals zero. If the usage count does equal zero for the requested resource, the process proceeds to setp 280 where that resource is turned on. The process then proceeds to step 282 where the usage count is incremented and the new count is recorded in database 39. If the determination is made at block 278 that the resource is already on, the process will proceed directly from block 278 to block 282. From block 282, the process proceeds to block 292 which is discussed below.

If the determination at block 270 determines that the request is not a request to use the resource, the assumption is made that the request is a request to release the resource. In this instance, the process will proceed to block 284 where the usage count for that resource will be decremented. The process will then make a determination at the next block 286 whether the decremented usage count is equal to zero. If the usage count does equal zero, the process will proceed to block 288 where the resource will be switched off. Then the process will proceed to block 290 where the now decremented usage count is recorded by the resource manager 36 in database 39. If, at block 286, it is determined that the usage count is not zero, the process will proceed directly to block 290. From block 290 the process proceeds to block 292.

Certain resources require time to stabilise after their level or usage count has altered. Therefore, at step 292 a determination is made whether the current resource requires stabilisation. If the resource does require stabilisation, the process proceeds to block 294 where the thread for the requesting driver(s) for that resource are arranged to sleep for a period of time sufficient to allow the resource to stabilise. Thereafter the process will terminate at block 296. Similarly, if it is determined at block 292 that no stabilisation is required, the process will go directly to block 296 where it will terminate.

It is to be realised that at each of the fail blocks 260 and 274 in the embodiment illustrated, appropriate error messages are returned to the requesting driver so that the failure may be handled gracefully.

In the above embodiment it is hardware drivers which request and use resources. In alternative embodiments, other software modules or hardware elements are the entities requesting and using the resources.

It will be understood by the skilled person that alternative implementations are possible, and that various modifications of the methods and implementations described above may be made within the scope of the invention, as defined by the appended claims. It should also be noted that any combination of the features and process elements described herein may be combined or omitted in different embodiments of the invention.

In the embodiments described above and illustrated in the accompanying Figures, the power resource manager is illustrated and described as a single component. However, in further embodiments, the functions of the resource manager are performed by a number of components. In further embodiments, the resource manager forms a subset of a larger component.

In the above mentioned embodiments, certain components have been described as software and others as hardware. It is to be realised that in many instances a component provided as hardware may be implemented in software and vice versa.

1. A resource manager configured to manage a plurality of hardware resources in a computing device in dependence on a record of each of said plurality of hardware resources and an indication of power dependencies between said plurality of hardware resources, wherein:
when a selected resource has more than one dependency, said resource manager is configured to manage said selected resource in dependence on a priority associated with one or more dependencies of said selected resource, and
the resource manager is further configured:
to alter a state of a target resource in dependence on information in one or more of said records, or one or more of said indications of dependencies, corresponding to said target resource, and
to alter said states of said dependent resources in dependence on said priorities.

2-4. (canceled)

5. The resource manager according to claim 1 configured to verify that no circular dependencies exist for a given record.

6. The resource manager according to claim 5 configured to perform said verification after the given record is established and before the given record is utilised.

7. The resource manager according to claim 1 configured to manage said resources when dependencies between said resources is represented by a graph, wherein one or more of said records is a node of said graph and said dependencies are edges of said graph.

8. The resource manager according to claim 1 configured to maintain said records and said indications of dependencies.

9. The resource manager according to claim 8 wherein said resource manager is configured to establish a record for a static resource when the computing device is booting.

10. The resource manager according to claim 8 wherein said resource manager is configured to establish a record for a dynamic resource when said dynamic resource is added to said computing device.

11-13. (canceled)

14. The resource manager according to claim 1 configured to:
determine resources which are dependent upon said target resource with reference to said one or more records or said one or more indications of dependencies corresponding to said target resource,
determine an effect a change of state of said target resource will have on one or more resources determined to be dependent on said target resource, and
change said state of said target resource only if an effect of said change on one or more resource dependent upon said target resource is determined to be acceptable.

15-17. (canceled)

18. The resource manager according to claim 14 configured to alter states of said one or more dependent resources prior to altering said state of said target resource to said target state.

19. (canceled)

20. The resource manager according to claim 1 configured to alert one or more clients of said target resource in accordance with information contained in said records.

21. The resource manager according to claim 20 configured to alert one or more clients of one or more resources forming a dependency with said target resource to said change prior to clients of said target resource being alerted to said change.

22. A method comprising: establishing a record of each of a plurality of hardware resources in a computing device, and maintaining an indication of power dependencies between said plurality of hardware resources, the method further comprising:
when a selected resource has more than one dependency, associating a priority with one or more dependencies of said selected resource
altering a state of a target resource in dependence on said one or more records or said one or more indications of dependencies corresponding to said target resource, and
altering one or more states of said dependent resources in dependence on said priorities.

23-25. (canceled)

26. The method according to claim 22 further comprising verifying that no circular dependencies exist for a given record.

27. The method according to claim 26 wherein said verification is performed after the given record is established and before the given record is utilised.

28. The method according to claim 22 wherein establishing a record for a static resource occurs when the computing device is booting.

29. The method according to claim 22 wherein establishing a record for a dynamic resource occurs when said dynamic resource is added to said computing device.

30. (canceled)

31. The method according to claim 22 comprising representing said dependencies between resources as a graph, wherein one or more of said records is a node of said graph and one or more of said dependencies is an edge of said graph.

32. The method according to claim 31, wherein said edges are weighted according to said priorities.

33-37. (canceled)

38. The method according to claim 22 further comprising altering one or more states of said dependent resources prior to altering said state of said target resource to said target state.

39-42. (canceled)

43. A computer readable memory storing a computer program, said computer program being configured, when operating on a processor of a computer to cause the processor to perform at least the following:
establishing a record of each of a plurality of hardware resources in a computing device, and maintaining an indication of power dependencies between said plurality of hardware resources;
when a selected resource has more than one dependency, associating a priority with one or more dependencies of said selected resource,
altering a state of a target resource in dependence on said one or more records or said one or more indications of dependencies corresponding to said target resource, and
altering one or more states of said dependent resources in dependence on said priorities.

44-46. (canceled)
